(19) United States
(12) Patent Application Publication
(10) Pub. No.: US 2021/0400179 A1
(43) Pub. Date: Dec. 23, 2021

(54) SENSOR SYSTEM WITH CLEANING AND HEATING

(71) Applicant: Ford Global Technologies, LLC, Dearborn, MI (US)

(72) Inventors: LaRon Michelle Brown, Detroit, MI (US); Rashaun Phinisee, Ypsilanti, MI (US); Prashant Dubey, Canton, MI (US); Venkatesh Krishnan, Canton, MI (US); Segundo Baldovino, Novi, MI (US)

(73) Assignee: Ford Global Technologies, LLC, Dearborn, MI (US)

(21) Appl. No.: 16/904,703

(22) Filed: Jun. 18, 2020

(51) Int. Cl. H04N 5/225; G01K 7/04; G01K 3/14; F25D 21/00; F25D 21/08; G03B 17/55; G02B 27/00

(52) U.S. Cl. CPC H04N 5/22521; G01K 7/04; G01K 3/14; F25D 21/006; G02B 27/0006; H04N 5/2252; H04N 5/2253; G03B 17/55; F25D 21/08

(57) ABSTRACT

A sensor system includes a camera including a lens, a casing extending around the lens, at least three heating elements embedded in the casing and arranged circumferentially around the lens, and a computer communicatively coupled to the camera and to the heating elements. The computer is programmed to, upon detecting ice at a location on the lens, select a first subset of the heating elements based on the location of the ice; activate the first subset of the heating elements to a first heating level; determine a second heating level based on an ambient temperature and a lens temperature; and activate a second subset of the heating elements to the second heating level, the second subset including the heating elements not in the first subset.

### BACKGROUND

Vehicles typically include sensors. The sensors can provide data about operation of the vehicle, for example, wheel speed, wheel orientation, and engine and transmission data (e.g., temperature, fuel consumption, etc.). The sensors can detect the location and/or orientation of the vehicle. The sensors can be global positioning system (GPS) sensors; accelerometers such as piezo-electric or microelectromechanical systems (MEMS); gyroscopes such as rate, ring laser, or fiber-optic gyroscopes; inertial measurements units (IMU); and/or magnetometers. The sensors can detect the external world, e.g., objects and/or characteristics of surroundings of the vehicle, such as other vehicles, road lane markings, traffic lights and/or signs, pedestrians, etc. For example, the sensors can be radar sensors, scanning laser range finders, light detection and ranging (LIDAR) devices, and/or image processing sensors such as cameras.

### BRIEF DESCRIPTION OF THE DRAWINGS

FIG. 1 is a perspective view of an example vehicle.

FIG. 2 is a perspective view of an example housing on the vehicle.

FIG. 3 is an exploded view of the housing.

FIG. 4 is a side cross-sectional view of the housing.

FIG. 5 is a perspective view of the housing with a chamber exposed for illustration.

FIG. 6 is a perspective view of a portion of the housing.

FIG. 7 is a perspective view of a portion of a sensor assembly.

FIG. 8 is an exploded rear perspective view of a portion of the sensor assembly.

FIG. 9 is a side cross-sectional view of a portion of the sensor assembly.

FIG. 10 is a block diagram of a control system for the sensor assembly.

FIG. 11 is a process flow diagram of an example process for controlling heating elements of the sensor assembly.

### DETAILED DESCRIPTION

A sensor system includes a camera including a lens, a casing extending around the lens, at least three heating elements embedded in the casing and arranged circumferentially around the lens, and a computer communicatively coupled to the camera and to the heating elements. The computer is programmed to, upon detecting ice at a location on the lens, select a first subset of the heating elements based on the location of the ice; activate the first subset of the heating elements to a first heating level; determine a second heating level based on an ambient temperature and a lens temperature; and activate a second subset of the heating elements to the second heating level, the second subset including the heating elements not in the first subset.

The sensor system may further include a housing including a chamber, and the camera and the casing may be disposed in the chamber. The housing may include an aperture, the lens may define a field of view of the camera through the aperture, and the casing and the housing may form an air nozzle extending at least partway around the aperture. The air nozzle may be shaped to direct airflow from the chamber across the lens.

The sensor system may further include a seal affixed to the casing, extending partway around the aperture, and contacting the housing. The air nozzle and the seal may collectively extend fully around the aperture.

The seal may block airflow from the chamber through the aperture except through the air nozzle.

The sensor system may further include a pressure source positioned to raise a pressure in the chamber above an atmospheric pressure. The pressure source may be a blower.

The lens may define an axis, the casing may include an outer surface facing radially outward relative to the axis, and the outer surface may be exposed to the chamber.

The sensor system may further include a temperature sensor communicatively coupled to the computer and spaced from the housing, and the computer may be further programmed to receive the ambient temperature from the temperature sensor. The housing may be mounted to a roof of a vehicle, and the temperature sensor may be mounted to a front end of the vehicle.

The sensor system may further include a thermocouple communicatively coupled to the computer and thermally coupled to the lens, and the computer may be further programmed to receive the lens temperature from the thermocouple.

The lens temperature may be a sensed lens temperature, and determining the second heating level based on the ambient temperature and the lens temperature may include determining a target lens temperature based on the ambient temperature, and determining the second heating level based on a difference between the sensed lens temperature and the target lens temperature. The camera may include a camera body including an outer surface, and the second heating level may also be based on a camera-body temperature of the outer surface of the camera body. The sensor system may further include a thermocouple communicatively coupled to the computer and thermally coupled to the outer surface of the camera body, and the computer may be further programmed to receive the camera-body temperature.

The lens may include zones corresponding respectively to the heating elements, and the first subset of heating elements may include each heating element for which the location of the ice is in the zone corresponding to that heating element.

With reference to the Figures, a sensor system 32 for a vehicle 30 includes at least one camera 34 including a lens 36, a casing 38 extending around the lens 36, at least three heating elements 40 embedded in the casing 38 and arranged circumferentially around the lens 36, and a computer 42 communicatively coupled to the camera 34 and to the heating elements 40. The computer 42 is programmed to, upon detecting ice at a location on the lens 36, select a first subset of the heating elements 40 based on the location of the ice; activate the first subset of the heating elements 40 to a first heating level; determine a second heating level based on an ambient temperature and a lens temperature; and activate a second subset of the heating elements 40 to the second heating level, the second subset including the heating elements 40 not in the first subset.

The sensor system 32 can remove ice as well as eliminate or prevent condensation on the lens 36. The sensor system 32 can do so in an energy-efficient manner by activating only the first subset of the heating elements 40 for ice removal and activating only the second subset of the heating elements 40 for condensation, as well as by selecting the second heating level for the second subset of the heating elements 40. The embedding of the heating elements 40 can provide heating for the lens 36 without causing distortion of the lens 36. The arrangement of the heating elements 40 can provide localized heating for different areas of the lens 36.

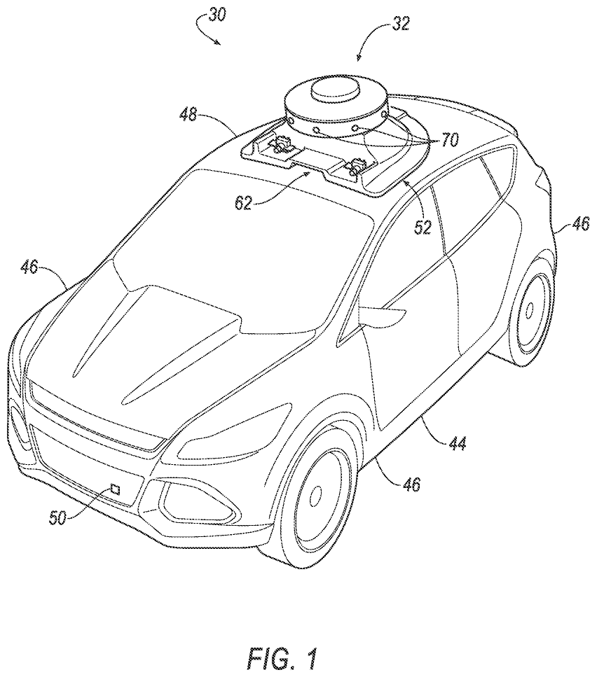

With reference to FIG. 1, the vehicle 30 may be any passenger or commercial automobile such as a car, a truck, a sport utility vehicle, a crossover vehicle, a van, a minivan, a taxi, a bus, etc.

The vehicle 30 may be an autonomous vehicle. A vehicle computer can be programmed to operate the vehicle 30 independently of the intervention of a human driver, completely or to a lesser degree. The vehicle computer may be programmed to operate the propulsion, brake system, steering, and/or other vehicle systems. For the purposes of this disclosure, autonomous operation means the vehicle computer controls the propulsion, brake system, and steering without input from a human driver; semi-autonomous operation means the vehicle computer controls one or two of the propulsion, brake system, and steering and a human driver controls the remainder; and nonautonomous operation means a human driver controls the propulsion, brake system, and steering. The vehicle computer may rely on data from the cameras 34 to autonomously or semi-autonomously operate the vehicle 30.

The vehicle 30 includes a body 44. The vehicle 30 may be of a unibody construction, in which a frame and the body 44 of the vehicle 30 are a single component. The vehicle 30 may, alternatively, be of a body-on-frame construction, in which the frame supports the body 44 that is a separate component from the frame. The frame and the body 44 may be formed of any suitable material, for example, steel, aluminum, etc.

The body 44 includes body panels 46 partially defining an exterior of the vehicle 30. The body panels 46 may present a class-A surface, e.g., a finished surface exposed to view by a customer and free of unaesthetic blemishes and defects. The body panels 46 include, e.g., a roof 48, etc.

The sensor system 32 can include a temperature sensor 50. The temperature sensor 50 detects a temperature of a surrounding environment or an object in contact with the temperature sensor 50. The temperature sensor 50 may be any device that generates an output correlated with temperature, e.g., a thermometer, a bimetallic strip, a thermistor, a thermocouple, a resistance thermometer, a silicon bandgap temperature sensor, etc. In particular, the temperature sensor 50 can be an outside air temperature sensor (OATS) that detects the ambient temperature, i.e., the temperature of the ambient environment. The temperature sensor 50 is mounted to the vehicle 30 and spaced from a housing 52 for the cameras 34. For example, the temperature sensor 50 is mounted to a front end, e.g., a grill, of the vehicle 30.

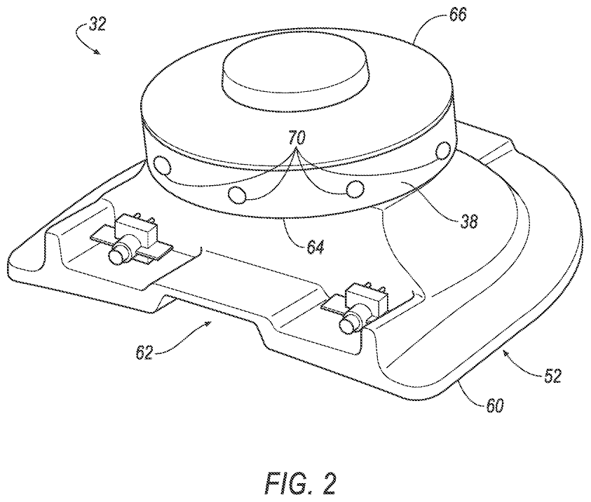

With reference to FIGS. 1 and 2, the housing 52 for the cameras 34 is mountable to the vehicle 30, e.g., to one of the body panels 46 of the vehicle 30, e.g., the roof 48. For example, the housing 52 may be shaped to be attachable to the roof 48, e.g., may have a shape matching or following a contour of the roof 48. The housing 52 may be mounted to the roof 48, which can provide the cameras 34 with an unobstructed field of view of an area around the vehicle 30. The housing 52 may be formed of, e.g., plastic or metal.

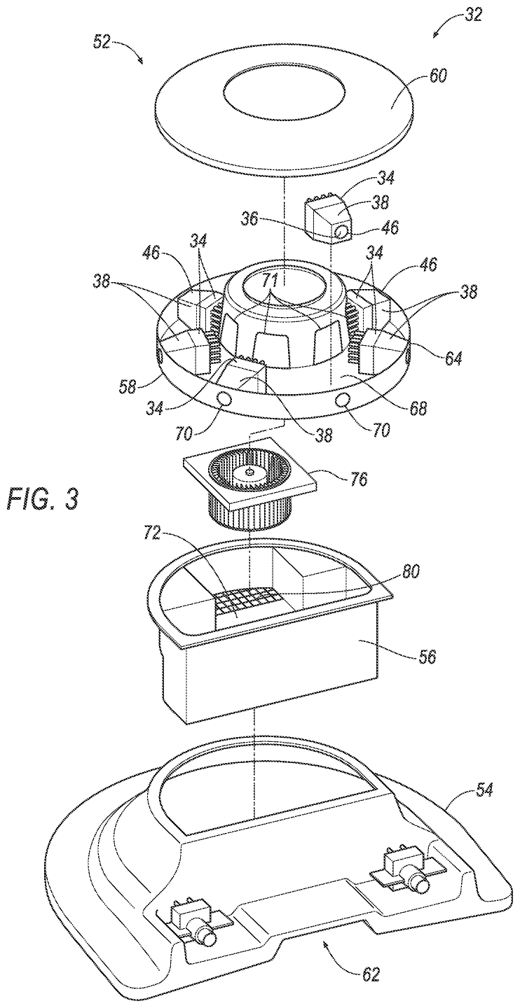

With reference to FIG. 3, the housing 52 includes a foundation 54, a bucket 56, a tray 58, and a top cover 60. The foundation 54 is attached to the roof 48 and includes an intake opening 62. The intake opening 62 is positioned to face forward when the housing 52 is mounted on the vehicle 30. The foundation 54 has a bottom surface shaped to conform to the roof 48 of the vehicle 30 and a top surface with an opening shaped to receive the bucket 56.

The bucket 56 sits in the foundation 54. The bucket 56 is a container with an open top, i.e., a tubular shape with a closed bottom and an open top. The bucket 56 includes a lip at the top shaped to catch on the top of the base. The bucket 56 has a substantially constant cross-section along a vertical axis between the top and the bottom.

The tray 58 sits on top of the foundation 54 and the bucket 56. The cameras 34 are disposed in the tray 58. The tray 58 includes a panel 64, which serves as a circumferential outer wall, and the tray 58 includes a circumferential inner wall 66. The panel 64 and the inner wall 66 each has a cylindrical or frustoconical shape. The tray 58 includes a floor 68 extending radially outward from the inner wall 66 to the panel 64. The panel 64 of the tray 58 includes a plurality of apertures 70 each corresponding to one of the cameras 34. The inner wall 66 includes tray openings 71 positioned radially inwardly from respective cameras 34 relative to the tray 58.

The top cover 60 is attached to the tray 58 and encloses the tray 58 from the inner wall 66 to the panel 64. The top cover 60 includes a hole sized to receive the inner wall 66 of the tray 58. The top cover 60 extends radially outward relative to the tray 58 from the inner wall 66 to the panel 64. The tray 58 and the top cover 60 together form a toroidal shape.

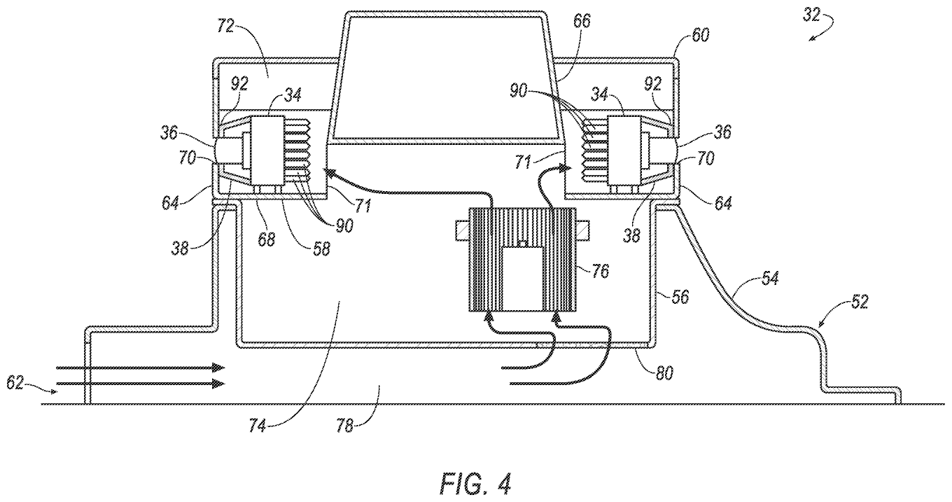

With reference to FIG. 4, the housing 52 includes the first chamber 72 in which the cameras 34 are disposed, and the housing 52 includes a second chamber 74 in which a pressure source 76 is disposed. The first chamber 72 may be disposed above the second chamber 74. For example, the tray 58 and the top cover 60 enclose and form the first chamber 72. For example, the foundation 54 and the bucket 56 enclose and form the second chamber 74, as shown in FIG. 4. Alternatively, one or more of the body panels 46, e.g., the roof 48, may partially enclose and form the second chamber 74 along with the foundation 54 and/or bucket 56.

The pressure source 76 increases the pressure of a gas occupying the first chamber 72. For example, the pressure source 76 may be a blower, which may force additional gas into a constant volume. The pressure source 76 may be any suitable type of blower, e.g., a positive-displacement compressor such as a reciprocating, ionic liquid piston, rotary screw, rotary vane, rolling piston, scroll, or diaphragm compressor; a dynamic compressor such as an air bubble, centrifugal, diagonal, mixed-flow, or axial-flow compressor; a fan; or any other suitable type.

The pressure source 76 is positioned to raise a pressure of the first chamber 72 above an atmospheric pressure. For example, the pressure source 76 is positioned to draw air from an ambient environment outside the housing 52 and to blow the air into the first chamber 72. The pressure source 76 is disposed in the second chamber 74 outside the first chamber 72, e.g., attached to the bucket 56 inside the bucket 56. For example, air enters through the intake opening 62, travels through a passageway 78 below the second chamber 74, travels through a filter 80 leading through a bottom of the bucket 56, and then travels to the pressure source 76. The filter 80 removes solid particulates such as dust, pollen, mold, dust, and bacteria from air flowing through the filter 80. The filter 80 may be any suitable type of filter, e.g., paper, foam, cotton, stainless steel, oil bath, etc. The pressure source 76 blows the air into the second chamber 74, and the air travels through the tray openings 71 into the first chamber 72.

Alternatively to the pressure source 76 being a blower, the sensor system 32 may pressurize the first chamber 72 of the housing 52 in other ways. For example, forward motion of the vehicle 30 may force air through passageways leading to the first chamber 72.

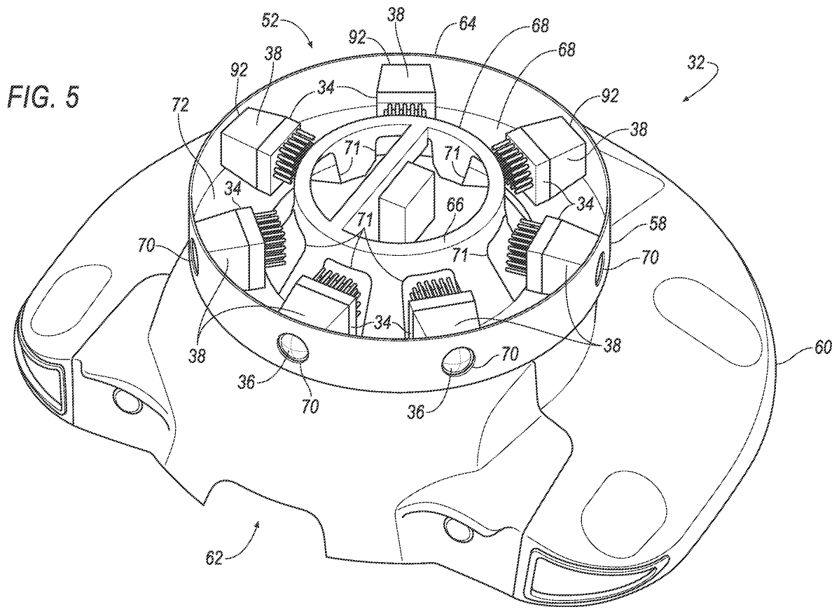

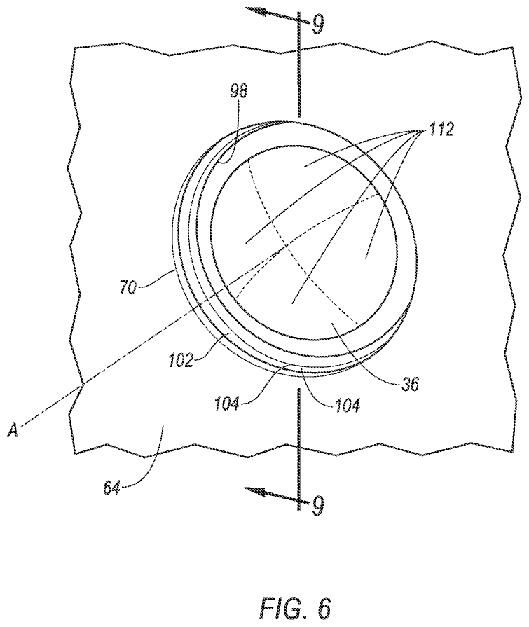

With reference to FIGS. 5 and 6, the housing 52 includes the apertures 70. The apertures 70 are holes in the housing 52 leading from the first chamber 72 to the ambient environment. The apertures 70 are through the panel 64 of the tray 58. The apertures 70 are circular in shape. The housing 52 includes one aperture 70 for each of the cameras 34. Each camera 34 has a field of view received through the respective aperture 70. The cameras 34 may extend into the respective apertures 70. For example, the aperture 70 may be concentric about a portion of the camera 34, e.g., the lens 36.

The cameras 34 disposed in the housing 52 may be arranged to collectively cover a 360° field of view with respect to a horizontal plane. The cameras 34 are fixed inside the first chamber 72. The cameras 34 are fixedly attached directly or indirectly to the housing 52. Each camera 34 has a field of view through the respective lens 36 and the respective aperture 70, and the field of view of one of the cameras 34 may overlap the fields of view of the cameras 34 that are circumferentially adjacent to one another, i.e., that are immediately next to each other.

The lenses may be convex. Each lens 36 may define the field of view of the respective camera 34 through the aperture 70. Each lens 36 defines an axis A, around which the lens 36 is radially symmetric. The axis A extends along a center of the field of view of the respective camera 34.

The cameras 34 can detect electromagnetic radiation in some range of wavelengths. For example, the cameras 34 may detect visible light, infrared radiation, ultraviolet light, or some range of wavelengths including visible, infrared, and/or ultraviolet light. For another example, the cameras 34 may be a time-of-flight (TOF) cameras, which include a modulated light source for illuminating the environment and detect both reflected light from the modulated light source and ambient light to sense reflectivity amplitudes and distances to the scene.

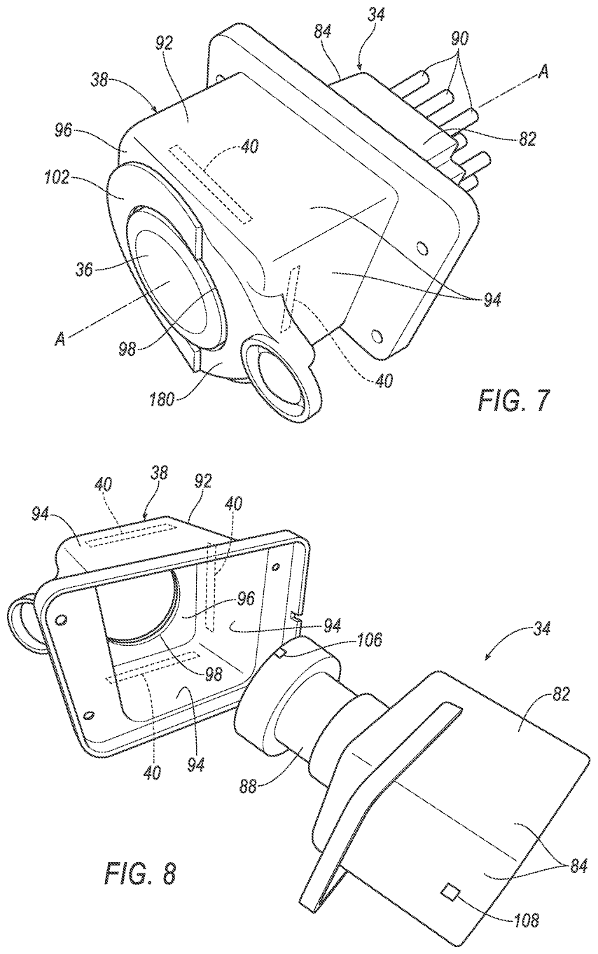

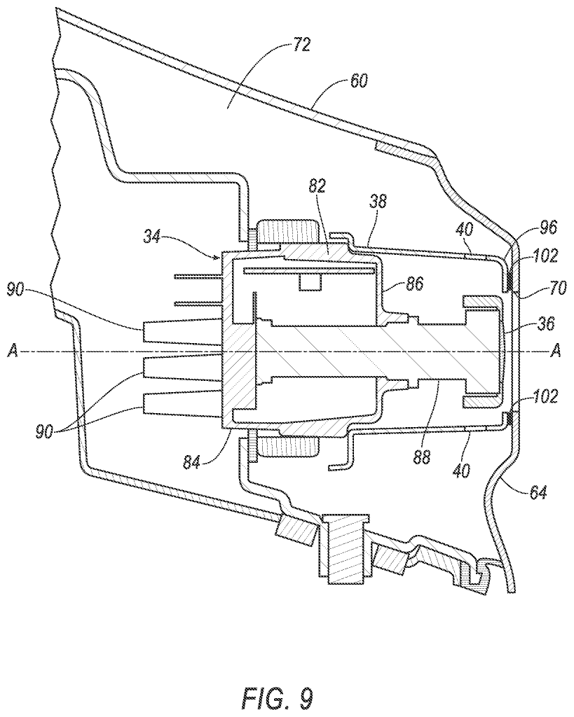

With reference to FIGS. 7-9, each camera 34 includes a camera body 82. The camera body 82 contains components for turning light focused by the lens 36 into a digital representation of the image, e.g., a mosaic filter, image sensor, analog-digital converter, etc. (not shown). The camera 34 is mounted to the housing 52 via the camera body 82. The camera body 82 includes an outer surface 84 facing outward, i.e., away from the components contained in the camera body 82. The outer surface 84 includes a front face 86 to which the casing 38 is mounted. The front face 86 faces toward the respective aperture 70.

Each camera 34 includes a camera tube 88. The camera tube 88 extends from the front face 86 of the camera body 82. The camera tube 88 is cylindrical. The camera tube 88 may be a single piece with the camera body 82 or may be a separate component fixed to the camera body 82. The camera tube 88 defines the axis A. The axis A can be perpendicular to a plane defined by the front face 86. The lens 36 is disposed at an end of the camera tube 88 farthest from the camera body 82. The lens 36 is thus spaced from the camera body 82. The camera tube 88 is elongated along the axis A from the camera body 82 to the lens 36.

Each camera 34 includes a plurality of fins 90. The fins 90 extend from the camera body 82 in an opposite direction as the camera tube 88 extends from the camera body 82. The fins 90 are thermally conductive, i.e., have a high thermal conductivity, e.g., a thermal conductivity equal to at least 15 watts per meter-Kelvin (W/(m K)), e.g., greater than 100 W/(m K), at 25° C. For example, the fins 90 may be aluminum. The fins 90 are shaped to have a high ratio of surface area to volume, e.g., long, thin poles or plates.

The casing 38 is mounted to the camera body 82 and disposed in the first chamber 72. The casing 38 extends from the camera body 82 to the lens 36. The casing 38 extends completely around the axis A, e.g., completely around the camera tube 88 and the lens 36. For example, the casing 38 can include a plurality of flat panels 94, e.g., four flat panels 94, connected together in a circumferential loop around the axis A. The casing 38 includes an outer surface 92 facing radially outward relative to the axis A. For example, the outer surface 92 can include surfaces of the flat panels 94 that face away from the axis A. The outer surface 92 is exposed to the first chamber 72. For the purposes of this disclosure, “A is exposed to B” means that a surface A is disposed within a volume defined and enclosed by a structure B without intermediate components shielding the surface A from the structure B.

The casing 38 can include a front panel 96 facing toward the panel 64 of the housing 52. The front panel 96 can border all of the flat panels 94. The front panel 96 includes a casing aperture 98 extending therethrough. The casing aperture 98 is circular and is centered on the axis A. The casing aperture 98 extends circumferentially around the lens 36.

The casing 38, specifically the front panel 96, includes a front surface 100. The front surface 100 faces toward the panel 64 of the housing 52. The front surface 100 extends circumferentially around the axis A from one end of a seal 102 on the casing 38 (described below) to the other end of the seal 102. The front surface 100 extends radially outward from the casing aperture 98. The front surface 100 slopes away from the panel 64 from the casing aperture 98 toward the flat panels 94. For example, the front surface 100 has a frustoconical shape around the axis A.

The seal 102 is attached to the casing 38, specifically affixed to the front panel 96 of the casing 38. The seal 102 is a layer on top of the front panel 96. The seal 102 extends from the casing aperture 98 radially outward toward the flat panels 94 relative to the axis A, and the seal 102 extends circumferentially about the axis A on the front panel 96 from one end of the front surface 100 to the other end of the front surface 100. The seal 102 extends circumferentially partially around the lens 36 and the aperture 70. The seal 102 contacts, i.e., abuts, the panel 64 of the housing 52 without being directly attached to the panel 64.

The seal 102 is elastomeric. An elastomeric material generally has a low Young's modulus and a high failure strain. The elastomeric material of the seal 102 reduces vibrations transmitted from the panel 64 to the camera 34. The seal 102 can be double-shot-molded with the casing 38, i.e., the casing 38 can be formed of a first material, the seal 102 can be formed of a second material different than the first material, with one of the materials injected into a mold while the other material is already in the mold and not yet solidified, resulting in molecular bonds between the two materials. The molecular bonds are stronger than when a first material is overmolded on another material that has already cooled.

An air nozzle 104 is formed of the casing 38 and the housing 52, specifically of the front surface 100 of the casing 38 and the panel 64 of the housing 52. The air nozzle 104 is shaped to guide airflow from the first chamber 72, which has higher-than-atmospheric pressure, into an air curtain across the lens 36. The air nozzle 104 is formed of the panel 64, the front surface 100 of the casing 38, and the seal 102. The front surface 100 extends along the air nozzle 104. The seal 102 is shaped to block airflow from the first chamber 72 through the aperture 70 other than through the air nozzle 104. The seal 102 contacts the panel 64, and the front surface 100 is spaced from the panel 64. The air nozzle 104 is annular and extends circumferentially around the axis A with the front surface 100. The air nozzle 104 and the front surface 100 extend circumferentially from one end of the seal 102 to the other end of the seal 102. The seal 102 is annular and extends circumferentially from one end of the air nozzle 104 to the other end of the air nozzle 104. The air nozzle 104 and the seal 102 collectively extend fully around the lens 36, i.e., 360° around the lens 36 and the aperture 70. For example, as shown in the Figures, the air nozzle 104 extends approximately 150°, and the seal 102 extends approximately 210°.

In operation, the pressure source 76 draws in air from the ambient environment and directs the air to the first chamber 72. The pressure source 76 causes the pressure of the first chamber 72 to increase above the atmospheric pressure outside the housing 52. The increased pressure forces air through the air nozzle 104. The shape of the air nozzle 104 causes the airflow to form an air curtain across the lens 36 of the camera 34. The air curtain can remove debris from the lens 36 as well as prevent debris from contacting the lens 36.

At least three heating elements 40 are embedded in the casing 38. The heating elements 40 are arranged circumferentially around the lens 36, i.e., around the axis A defined by the lens 36. For example, the heating elements 40 can include four heating elements 40, with one heating element 40 embedded in each of the flat panels 94 of the casing 38. The heating elements 40 are positioned close enough to the lens 36 to conduct generated heat to the lens 36.

The heating elements 40 can generate heating by resistive heating, also called Joule heating. The heating elements 40 are conductors, and the resistance of the heating elements 40 to electrical current flowing through the heating elements 40 generates the heat. The amount of heat generated by the heating elements 40 can be adjusted by adjusting the electrical current flowing through the heating elements 40.

A first thermocouple 106 is thermally coupled to the lens 36. A thermocouple is an electrical device of two dissimilar electrical conductors forming an electrical junction and which produces a temperature-dependent voltage as a result of the thermoelectric effect. For the purposes of this disclosure, “thermally coupled” means attached such that heat may efficiently flow and both ends of the thermal coupling (if separate) are substantially the same temperature within a short time period. For example, the first thermocouple 106 can contact a perimeter of the lens 36. The voltage returned by the first thermocouple 106 is thus the lens temperature, i.e., a temperature of the lens 36.

A second thermocouple 108 is thermally coupled to the outer surface 84 of the camera body 82. For example, the second thermocouple 108 can be affixed directly to the camera body 82. The voltage of the second thermocouple 108 is thus a camera-body temperature, i.e., a temperature of the camera body 82.

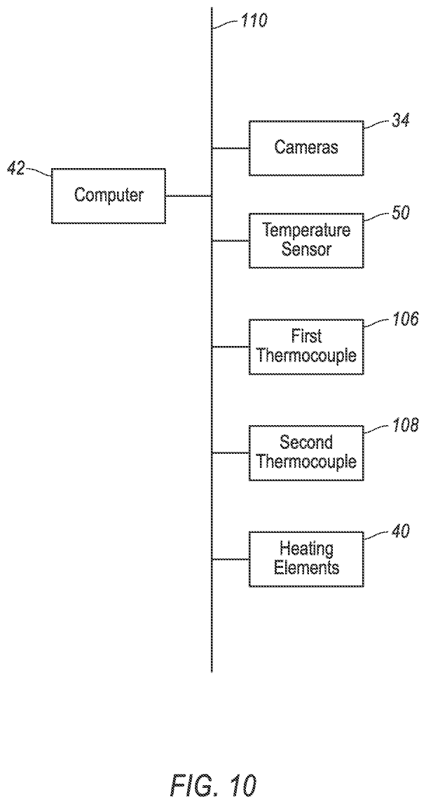

With reference to FIG. 10, the computer 42 is a microprocessor-based computing device, e.g., a generic computing device including a processor and a memory, an electronic controller or the like, a field-programmable gate array (FPGA), an application-specific integrated circuit (ASIC), etc. The computer 42 can thus include a processor, a memory, etc. The memory of the computer 42 can include media for storing instructions executable by the processor as well as for electronically storing data and/or databases, and/or the computer 42 can include structures such as the foregoing by which programming is provided. The computer 42 can be multiple computers coupled together.

The computer 42 may transmit and receive data through a communications network 110 such as a controller area network (CAN) bus, Ethernet, WiFi, Local Interconnect Network (LIN), onboard diagnostics connector (OBD-II), and/or by any other wired or wireless communications network. The computer 42 may be communicatively coupled to the cameras 34, the temperature sensor 50, the first thermocouple 106, the second thermocouple 108, the heating elements 40, and other components via the communications network 110.

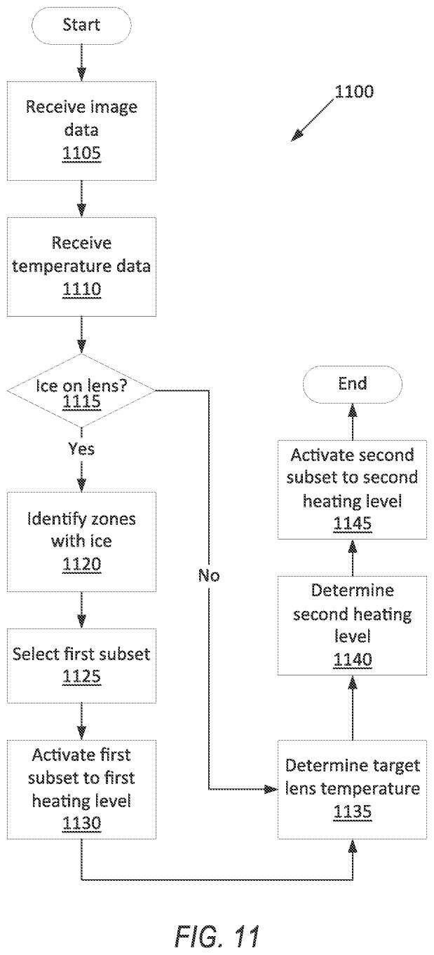

FIG. 11 is a process flow diagram illustrating an exemplary process 1100 for controlling the heating elements 40. The memory of the computer 42 stores executable instructions for performing the steps of the process 1100 and/or programming can be implemented in structures such as mentioned above. As a general overview of the process 1100, the computer 42 receives image data and temperature data, selects a first subset of the heating elements 40 and activates the first subset to a first heating level in response to detecting ice on the lens 36, and activates a second subset of the heating elements 40 to a second heating level based on the temperature data. The second subset includes the heating elements 40 that are not in the first subset. The process 1100 is performed independently for each camera 34 and respective heating elements 40.

The process 1100 begins in a block 1105, in which the computer 42 receives image data from the camera 34. The image data are a sequence of image frames of the field of view of the camera 34. Each image frame is a two-dimensional matrix of pixels. Each pixel has a brightness or color represented as one or more numerical values, e.g., a scalar unitless value of photometric light intensity between 0 (black) and 1 (white), or values for each of red, green, and blue, e.g., each on an 8-bit scale (0 to 255) or a 12- or 16-bit scale. The pixels may be a mix of representations, e.g., a repeating pattern of scalar values of intensity for three pixels and a fourth pixel with three numerical color values, or some other pattern. Position in an image frame, i.e., position in the field of view of the sensor at the time that the image frame was recorded, can be specified in pixel dimensions or coordinates, e.g., an ordered pair of pixel distances, such as a number of pixels from a top edge and a number of pixels from a left edge of the field of view.

Next, in a block 1110, the computer 42 receives temperature data including the ambient temperature T_{amb} from the temperature sensor 50, the lens temperature T_{L} from the first thermocouple 106, and the camera-body temperature T_{C} from the second thermocouple 108. The temperatures are all represented in the same units of temperature, e.g., degrees Celsius (° C.).

Next, in a decision block 1115, the computer 42 determines whether ice is detected on the lens 36. The computer 42 can identify ice using conventional image-recognition techniques, e.g., a convolutional neural network programmed to accept images as input and output an identified object. A convolutional neural network includes a series of layers, with each layer using the previous layer as input. Each layer contains a plurality of neurons that receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network generates a score for each potential object, and the final output is the object with the highest score. If “ice” has the highest score, the process 1100 proceeds to a block 1120. If “ice” does not have the highest score, the process 1100 proceeds to a block 1135.

In the block 1120, the computer 42 identifies a location of the ice on the lens 36. The lens 36 includes zones 112 corresponding respectively to the heating elements 40, as shown in FIG. 6. Each zone 112 can be all the points on a surface of the lens 36 that are closest to a respective heating element 40. The location of the ice is the one or more zones 112 in which the ice is located. The computer 42 determines the location of the ice according to the position in the image frame of the object identified as the ice. The memory of the computer 42 can store a mapping of the positions of the image frame in pixel dimensions to the zones 112 of the lens 36.

Next, in a block 1125, the computer 42 selects the first subset of the heating elements 40 based on the location of the ice. The first subset of the heating elements 40 includes each heating element 40 for which the location of the ice is in the zone 112 corresponding to that heating element 40. In other words, for each zone 112 with ice, the corresponding heating element 40 is included in the first subset.

Next, in a block 1130, the computer 42 activates the first subset of the heating elements 40 to the first heating level. For the purposes of this disclosure, a “heating level” is a target heat output from one of the heating elements 40. For example, the first heating level can be a predefined electrical current passing through one of the heating elements 40. The electrical current for a heating element 40 can be controlled, e.g., by adjusting a voltage across that heating element 40. After the block 1130, the process 1100 proceeds to the block 1135.

In the block 1135, the computer 42 determines a target lens temperature T_{L,target} based on the ambient temperature T_{amb}. The target lens temperature T_{L,target} is a lens temperature to be achieved by activating the heating elements 40. (The lens temperature T_{L} returned by the first thermocouple 106 in the block 1110 is referred to as the sensed lens temperature T_{L,sens}.) The memory of the computer 42 can store a lookup table with values for the ambient temperature T_{amb} paired with corresponding values for the target lens temperature T_{L,target}. The values of the target lens temperature T_{L,target} can be chosen by experimenting to determine, for each value for the ambient temperature T_{amb}, what minimum lens temperature T_{L} is necessary to prevent condensation on the lens 36.

Next, in a block 1140, the computer 42 determines the second heating level based on the ambient temperature T_{amb}, the sensed lens temperature T_{L,sens}, and the camera-body temperature T_{C} from the block 1110. First, the computer 42 determines a difference ΔT_{L} between the target lens temperature T_{L,target} from the block 1135 and the sensed lens temperature T_{L,sens}, i.e., ΔT_{L}=T_{L,target}−T_{L,sens}. Second, the computer 42 determines the second heating level based on the difference ΔT_{L} and the camera-body temperature T_{C}. For example, the computer 42 can look up a value for the second heating level in a lookup table. The memory of the computer 42 can store the lookup table with pairs of the difference ΔT_{L} and the camera-body temperature T_{C} and with values of the second heating level corresponding to the pairs. For another example, the computer 42 can determine the second heating level H₂ as a function of the difference ΔT_{L} and the camera-body temperature T_{C}, i.e., H₂=f(ΔT_{L}, T_{C}). Both the values of the lookup table and the function are chosen according to experimentally determining what will cause the sensed lens temperature T_{L,sens} to approach the target lens temperature T_{L,target} without overshooting, i.e., T_{L,sens}=T_{L,target} at equilibrium. In general, the second heating level increases with the difference ΔT_{L} and decreases with the camera-body temperature T_{C}.

Next, in a block 1145, the computer 42 activates the second subset of the heating elements 40 to the second level. The second subset includes the heating elements 40 not in the first subset. After the block 1145, the process 1100 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. Use of “in response to,” “upon determining,” or “upon detecting” indicates a causal relationship, not merely a temporal relationship. The adjectives “first” and “second” are used throughout this document as identifiers and are not intended to signify importance, order, or quantity.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A sensor system comprising:
a camera including a lens;
a casing extending around the lens;
at least three heating elements embedded in the casing and arranged circumferentially around the lens; and
a computer communicatively coupled to the camera and to the heating elements;
wherein the computer is programmed to:
upon detecting ice at a location on the lens, select a first subset of the heating elements based on the location of the ice;
activate the first subset of the heating elements to a first heating level;
determine a second heating level based on an ambient temperature and a lens temperature; and
activate a second subset of the heating elements to the second heating level, the second subset including the heating elements not in the first subset.

2. The sensor system of claim 1, further comprising a housing including a chamber, wherein the camera and the casing are disposed in the chamber.

3. The sensor system of claim 2, wherein the housing includes an aperture, the lens defines a field of view of the camera through the aperture, and the casing and the housing form an air nozzle extending at least partway around the aperture.

4. The sensor system of claim 3, wherein the air nozzle is shaped to direct airflow from the chamber across the lens.

5. The sensor system of claim 3, further comprising a seal affixed to the casing, extending partway around the aperture, and contacting the housing.

6. The sensor system of claim 5, wherein the air nozzle and the seal collectively extend fully around the aperture.

7. The sensor system of claim 5, wherein the seal blocks airflow from the chamber through the aperture except through the air nozzle.

8. The sensor system of claim 2, further comprising a pressure source positioned to raise a pressure in the chamber above an atmospheric pressure.

9. The sensor system of claim 8, wherein the pressure source is a blower.

10. The sensor system of claim 2, wherein the lens defines an axis, the casing includes an outer surface facing radially outward relative to the axis, and the outer surface is exposed to the chamber.

11. The sensor system of claim 2, further comprising a temperature sensor communicatively coupled to the computer and spaced from the housing, wherein the computer is further programmed to receive the ambient temperature from the temperature sensor.

12. The sensor system of claim 11, wherein the housing is mounted to a roof of a vehicle, and the temperature sensor is mounted to a front end of the vehicle.

13. The sensor system of claim 1, further comprising a thermocouple communicatively coupled to the computer and thermally coupled to the lens, wherein the computer is further programmed to receive the lens temperature from the thermocouple.

14. The sensor system of claim 1, wherein
the lens temperature is a sensed lens temperature; and
determining the second heating level based on the ambient temperature and the lens temperature includes determining a target lens temperature based on the ambient temperature, and determining the second heating level based on a difference between the sensed lens temperature and the target lens temperature.

15. The sensor system of claim 14, wherein the camera includes a camera body including an outer surface, and the second heating level is also based on a camera-body temperature of the outer surface of the camera body.

16. The sensor system of claim 15, further comprising a thermocouple communicatively coupled to the computer and thermally coupled to the outer surface of the camera body, wherein the computer is further programmed to receive the camera-body temperature.

17. The sensor system of claim 1, wherein the lens includes zones corresponding respectively to the heating elements, and the first subset of heating elements includes each heating element for which the location of the ice is in the zone corresponding to that heating element.
